(19) United States
(12) Patent Application Publication
(10) Pub. No.: US 2014/0149260 A1
(43) Pub. Date: May 29, 2014

(54) GIFT ENTITLEMENT NOTIFICATION AND DELIVERY SYSTEMS AND METHODS

(71) Applicants: Kishore Konakanchi, San Jose, CA (US); Gabe Cohn, Berkeley, CA (US); Karen Rodriquez Ortega, Berkeley, CA (US); Dale Fedun, Berkeley, CA (US)

(72) Inventors: Kishore Konakanchi, San Jose, CA (US); Gabe Cohn, Berkeley, CA (US); Karen Rodriquez Ortega, Berkeley, CA (US); Dale Fedun, Berkeley, CA (US)

(21) Appl. No.: 14/041,101

(22) Filed: Sep. 30, 2013

Related U.S. Application Data
(60) Provisional application No. 61/729,998, filed on Nov. 26, 2012.

(51) Int. Cl. G06Q 30/06

(52) U.S. Cl. CPC G06Q 30/0635
USPC 705/26.81

(57) ABSTRACT

There is provided systems and method for a gift entitlement notification and delivery. A payment provider server may receive a gift entitlement from a first user. A gift entitlement may correspond to a gift for a second user, such as a credit at a merchant. The gift entitlement may be known or unknown to the second user. The gift may be retained by the payment provider until the second user is in a gifting opportunity with the merchant, for example, by traveling to the merchant and/or purchasing items with the merchant. If the gifting opportunity qualifies for the gift entitlement, the gift entitlement may be transmitted to the second user or the merchant. The gifting opportunity may qualify for the gift entitlement by meeting the terms attached to the gift entitlement.

### CROSS REFERENCE TO RELATED APPLICATION

Pursuant to 35 U.S.C. §119(e), this application claims priority to the filing date of U.S. Provisional Patent Application Ser. No. 61/729,998, filed Nov. 26, 2012, which is incorporated by reference in its entirety.

### BACKGROUND

1. Technical Field

The present application generally relates to gift entitlement notification and delivery and more specifically to determining if a user is involved in a gifting opportunity corresponding to a gift entitlement and delivering the gift entitlement to the user.

2. Related Art

A user may wish to send another user a gift card or certificate for various reasons including birthdays, holidays, thanks, and even just as daily pick-me-ups. Often, however, this requires the user to purchase a card at a store or merchant location, prepare the card, and personally hand the card to a recipient when the user meets the recipient. Gift certificates may be purchased and transmitted online, such as through email, but suffer from lack of presentation and require the recipient to print out the certificate or write down an identification number to redeem the card. Recipients are required to carry any gift cards/certificates they have and remember to utilize them to purchase goods. Gift cards/certificates that are awarded for specific dollar amounts often retain small monetary amounts, which may never be redeemed. Additionally, any digital or real gift certificate may become forgotten and expire after a certain amount of time.

### BRIEF DESCRIPTION OF THE DRAWINGS

FIG. 1 is a block diagram of a networked system suitable for implementing the process described herein according to an embodiment;

FIG. 2 is an exemplary gift entitlement delivery at a merchant location according to an embodiment;

FIG. 3 is a flowchart of an exemplary process for gift entitlements to a user after determining a user is in a gifting opportunity at a merchant according to an embodiment; and

FIG. 4 is a block diagram of a computer system suitable for implementing one or more components in FIG. 1 according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

In various embodiments, a user may establish a gift entitlement for a recipient with a payment provider and/or a merchant. For example, a user may purchase a gift entitlement for a recipient for $5, a particular item, or a specific service at a merchant. The user may purchase the gift from a payment provider, such as by accessing a payment provider server, selecting a gift entitlement, and completing purchase of the gift entitlement. In other embodiments, the user may purchase a gift entitlement with a merchant who may retain the gift entitlement in a merchant server database, or may transmit the gift to the payment provider. The gift entitlement may be unknown to the recipient. Later, when the recipient enters into a gifting opportunity with the merchant, the gift entitlement may be transmitted to the user if the gifting opportunity qualifies for the gift entitlement. Thus, the recipient may be surprised by an unexpected gift entitlement. In various embodiments, the gift entitlement may be transmitted to the merchant instead of the user, allowing the merchant to complete payment of the item/service with the gift entitlement. The recipient may utilize the gift entitlement at that point to purchase an item, or may save the gift entitlement for later use.

In some embodiments, a recipient may be determined to be in a gifting opportunity with a merchant based on a payment request for an item at a merchant location by the recipient. For example, the recipient may enter a merchant location and attempt to pay for an item. A payment provider and/or merchant server may receive the payment request for the item and determine the recipient is in a gifting opportunity based on the payment request. The purchase request may be a request to pay for the item using a payment provider. Thus, the payment provider receives a notification of a payment request from the merchant. In other embodiments, the payment request may correspond to a request to purchase the item using a payment card, such a credit/debit card, of the recipient. In such embodiments, a merchant server and/or payment provider, with knowledge of the payment card or after a notification from a third party, may determine the user is in a gifting opportunity. Still, in other embodiments, the recipient may be determined to be in a gifting opportunity based on geographic location of the merchant and the recipient, for example, if the recipient checks-in at a merchant location or otherwise associates themselves with the merchant location (i.e. GPS location, discount/rebate card scan, etc.).

Thus, when a payment provider and/or merchant server determines a recipient is in a gifting opportunity, the payment provider and/or merchant server then determines if the gifting opportunity qualifies for the gift entitlement. The gift entitlement may correspond to a credit to purchase an item, a monetary credit, and/or a credit for services. Thus, where the recipient purchases a different item or services, the gift entitlement may not be transmitted to the recipient and/or merchant. The gift entitlement may include terms to redemption, for example, only on a specific day, time, holiday, or other term. If the gift entitlement is transmitted to the recipient and/or merchant, the recipient may choose to use the gift entitlement. However, in other embodiments, the recipient may store the gift entitlement to a digital wallet, such as an application on a smart phone. The recipient may also request and/or transmit the gift entitlement to be stored in a user account with a payment provider and/or merchant.

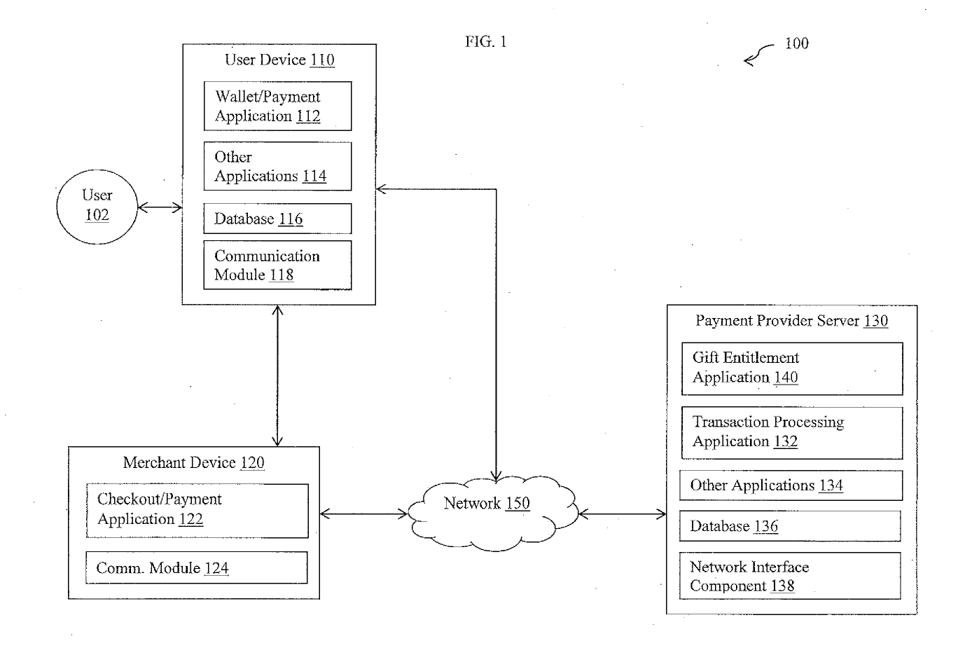

FIG. 1 is a block diagram of a networked system 100 suitable for implementing the process described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, a merchant device 120, and a payment provider server 130 in communication over a network 150. User 102, such as a consumer, may utilize user device 110 while visiting a merchant location, “checking-in” to a merchant location, browsing items at a merchant location, and/or purchasing items at a merchant location, such as a retail storefront. In certain embodiments, payment provider server 130 may receive information corresponding to a gifting opportunity of user 102. If the gifting opportunity qualifies for a gift entitlement previously established, payment provider server 130 may transmit the gift entitlement to user device 110 and/or merchant device 120.

User device 110, merchant device 120, and payment provider server 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

User device 110 may be implemented using any appropriate hardware and software configured for wired and/or wireless communication with merchant device 120 and/or payment provider server 130. For example, in one embodiment, user device 110 may be implemented as a personal computer (PC), a smart phone, personal digital assistant (PDA), laptop computer, wristwatch with appropriate computer hardware resources, eyeglasses with appropriate computer hardware (e.g. GOOGLE GLASS®) and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a wallet/payment application 112, other applications 114, a database 116, and a communication module 118. Wallet/payment application 112 and other applications 114 may correspond to processes, procedures, and/or applications executable by a hardware processor, for example, a software program. In other embodiments, user device 110 may include additional or different software as required.

Wallet/payment application 112 may be used, for example, to provide a convenient interface to permit user 102 to select payment options and provide payment for items and/or services. For example, wallet/payment application 112 may be implemented as an application having a user interface enabling the user to enter payment options for storage by user device 110, provide payment options on checkout/payment of an item/service, and complete a transaction for the item/service. In some embodiments, wallet/payment application 112 may correspond more generally to a web browser configured to view information available over the Internet or access a website corresponding to a wallet/payment application. Thus, wallet/payment application 112 may be utilized to access a website and engage in online transactions.

In various embodiments, wallet/payment application 112 may include options to store user financial account information, such as credit/debit card information, checking account information, and/or other user financial information. Wallet/payment application 112 may also store user payment accounts with a payment provider and/or merchant, and user gift entitlements. Gift entitlements may correspond to a credit with a merchant, such as a monetary credit, a credit for an item, and/or a credit for a service provided by the merchant. Gift entitlements may be unknown to user 102 prior to receiving the gift entitlement.

In various embodiments, wallet/payment application 112 may include an interface enabling user 102 to provide payment for an item with a merchant. For example, wallet/payment application 112 may transmit financial information, payment account information, and/or gift entitlement information to a merchant device, such as merchant device 120, on checkout/payment of the item/service. In other embodiments, wallet/payment application 112 may communicate with a payment provider, such as payment provider server 130, and/or a merchant server to complete payment of the item/service and transmit a transaction history to merchant device 120.

Wallet/payment application 112 may include a process to receive gift entitlements when a user is determined to be in a gifting opportunity with a merchant. A gifting opportunity may correspond to an opportunity to transmit a gift entitlement for user 102 to utilize during payment for an item/service. In some embodiments, wallet/payment application 112 may transmit a notification corresponding to a gifting opportunity between user 102 and a merchant to payment provider server 130 and/or a merchant server. For example, wallet/payment application 112 may transmit a purchase request to a merchant server and/or payment provider server 130 if user 102 utilizes wallet/payment application 112 to pay for an item/service. In other embodiments, payment provider server 130 and/or merchant server may receive a notification that user 102 is in a gifting opportunity with the merchant from another source. For example, user 102 may use a payment card (i.e. credit/debit card) to purchase an item/service at a merchant. User 102 may also associated a geographic location of user 102 to a geographic location of the merchant from a “check-in” application. Thus, merchant device 130, a social networking service, or other entity may transmit the gifting opportunity to payment provider server 130 and/or the merchant server.

In various embodiments, wallet/payment application 112 may also provide an interface permitting user 102 to manage user accounts, such as user accounts with payment provider server 130 and/or a merchant server. Wallet/payment application 112 may enable user 102 to access the user accounts, provide payment using the user accounts, or check and retrieve gift entitlements stored in one or more user accounts. Additionally, wallet/payment application 112 may be utilized to review gift entitlements available with payment provider server 140, including unused balances, balances remaining after partial use of a gift entitlement, and sent gift entitlements.

User device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 150, or other types of applications. Other applications 114 may also include email, texting, voice and IM applications that allow a user to send and receive emails, calls, texts, and other notifications through network 150. In various embodiments, other applications 114 may include financial applications, such as banking, online payments, money transfer, or other applications associated with payment provider server 130. Other applications may include “check-in” applications enabling user 102 to associate a position of user 102 with a geographic location, including a merchant location. Additionally, other application may include social media applications including a “check-in” process, GPS, and/or mapping applications. Other applications 114 may contain other software programs, executable by a processor, including a graphical user interface (GUI) configured to provide an interface to the user.

User device 110 may further include database 116 which may include, for example, identifiers such as operating system registry entries, cookies associated with browser/credit application 112 and/or other applications 114, identifiers associated with hardware of user device 110, or other appropriate identifiers, such as identifiers used for payment/user/device authentication or identification. In one embodiment, identifiers in database 116 may be used by a merchant server and/or payment provider, such as payment provider server 130, to associate user device 110 with a particular account maintained by the payment/credit provider.

In various embodiments, database 116 may further include user information data to access user information. Thus, database 116 may include user personal information (e.g. a name, social security number, user financial information, or other identifying information), a user account identifier, and a user device identifier. In various embodiments, database 116 may include online account access information. Database 116 may also store gift entitlements transferred to wallet/payment application 112 and retained by user 102. In some embodiments, user 102 may receive the gift entitlement and select to store a gift entitlement instead of using the gift entitlement, or may use only part of a gift entitlement, such as a portion of the monetary value of the gift entitlement. Thus, user 102 may request wallet/payment application 112 to store the gift entitlement in database 116.

In various embodiments, user device 110 includes at least one communication module 118 adapted to communicate with merchant device 120 and/or payment provider server 130. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Merchant device 120 may be maintained, for example, by a merchant or seller offering various items, products, and/or services through a merchant location. Generally, merchant device 120 may be maintained by anyone or any entity that receives money, which includes charities as well as retailers and restaurants. In this regard, merchant device 120 may include processing applications, which may be configured to interact with user device 110 and/or payment provider server 130 to facilitate the sale of products, goods, and/or services.

Merchant device 120 may be implemented using any appropriate hardware and software configured for wired and/or wireless communication with user device 110 and/or payment provider server 130. For example, in one embodiment, merchant device 120 may be implemented as a single or networked personal computer (PC), a smart phone, personal digital assistant (PDA), laptop computer, and/or other types of computing devices at a merchant location capable of transmitting and/or receiving data. Although a merchant device is shown, the merchant device may be managed or controlled by any suitable processing device. Although only one merchant device is shown, a plurality of merchant devices may be utilized.

Merchant device 120 includes a checkout/payment application 122 and a communication module 124. Checkout/payment application 122 may correspond to processes, procedures, and/or applications executable by a hardware processor, for example, a software program. In other embodiments, merchant device 120 may include additional or different software as required

Checkout/payment application 122 may be configured to provide a convenient interface to permit a salesperson to select, review, and sell items to user 102. For example, checkout/payment application 122 may be implemented as an application having an interface enabling user 102 to buy products available at a merchant corresponding to merchant device 120. Thus, checkout/payment application 122 may include an interface displaying user selected products for purchase, including product information, purchase price, and total purchase costs. In some embodiments, checkout/payment application 122 may correspond more generally to a web browser configured to view merchant information available over the Internet or access a website corresponding to products available from a merchant. Thus, checkout/payment application 122 may also be utilized to access merchant websites and engage in online transactions, for example, purchasing of inventory available in at other merchant locations, warehouses, or different merchants.

Checkout/payment application 122 may further include information corresponding to a payment method selected by user 102. For example, checkout/payment application 122 may include cash, check, credit/debit card, payment provider, gift entitlement, or other payment method. Checkout/payment application 122 may receive a payment method through input, such as swiping a payment card or entering a cash amount. Additionally, checkout/payment application 122 may be configured to interact with wallet/payment application 112 of user device 110 to receive a selected payment method. In such embodiments, checkout/payment application 122 may receive financial information, a payment provider including a user account with the payment provider, a gift entitlement, or a completed transaction history for a purchased item. Checkout/payment application 122 may also receive a gift entitlement for payment of an item/service from payment provider server 130 and/or a merchant server. For example, the gift entitlement may be unknown to user 102. Thus, when user 102 attempts to purchase an item, such as coffee and a merchant, the merchant may inform user 102 that the coffee has been paid for after receiving a gift entitlement corresponding to user 102.

Checkout/payment application 122 may process the payment method for the item/service. Checkout/payment application 122 may transmit information back to wallet/payment application 112 on completion of a purchase transaction, such as a receipt, a notification a gift entitlement has been accepted, and/or a current value of a gift entitlement used for payment. Thus, checkout/payment application 122 includes processes to accept a gift entitlement for an item/service and complete payment for the item/service using the gift entitlement. Checkout/payment application 122 may also transmit remaining balance of a gift entitlement to user device 110 and/or payment provider server 140 where only part of the gift entitlement is used.

In various embodiments, checkout/payment application 122 may include processes to transmit a notification to a merchant server and/or payment provider server 130 corresponding to a gifting opportunity for user 102. The notification may correspond to a payment request with a merchant. For example, checkout/payment application 122 may receive a payment request to use a payment provider and/or to use payment card for payment. Checkout/payment application 122 may transmit the information to a merchant server and/or payment provider server 130 to retrieve a gift entitlement corresponding to user 102 and the gifting opportunity. Thus, the merchant server and/or payment provider server 130 may transmit a gift entitlement corresponding to the gifting opportunity to user 102.

In various embodiments, merchant device 120 includes at least one communication module 124 adapted to communicate with user device 110 and/or payment provider server 130. In various embodiments, communication module 124 may include a DSL (e.g., Digital Subscriber Line) modem, a PSTN (Public Switched Telephone Network) modern, an Ethernet device, a broadband device, a satellite device and/or various other types of wired and/or wireless network communication devices including microwave, radio frequency, infrared, Bluetooth, and near field communication devices.

Payment provider server 130 may be maintained, for example, by an online payment service provider, which may provide gift entitlement services on behalf of one user to another user. In this regard, payment provider server 130 includes one or more processing applications which may be configured to interact with user device 110 and/or merchant device 120 to facilitate a transmission of a purchased gift entitlement to user 102 when user 102 is in a gifting opportunity corresponding to the gift entitlement. In one example, payment provider server 130 may be provided by PayPal®, Inc. of San Jose, Calif., USA. However, in other embodiments, payment provider server 130 may be maintained by or include a merchant, financial services provider, and/or other service provider, which may provide gift entitlements to users. Payment provider server 130 may additionally perform payment of goods, such as items and services, from merchant, and provide use of user accounts for payment of goods. Although payment provider server 130 is described as separate from a merchant and/or merchant server, it is understood that a merchant may include payment provider server 130. Thus, a merchant server may provide the same or similar operations as payment provider server 130 or may be incorporated within payment provider server 130.

Payment provider server 130 of FIG. 1 includes a gift entitlement application 140, a transaction processing application 132, other applications 134, a database 136, and a network interface component 138. Gift entitlement application 140, transaction processing application 132, and other applications 124 may correspond to processes, procedures, and/or applications executable by a hardware processor, for example, a software program. In other embodiments, payment provider server 130 may include additional or different software as required.

Gift entitlement application 140 of payment provider server 130 may be configured to establish gift entitlements, determine if a user is in a gifting opportunity that corresponds to a gift entitlement, and transmit the gift entitlement to the user. Gift entitlement application 140 may establish gift entitlement for user 102 and store the gift entitlements in database 136 for transmission to user 102. Gift entitlements may be known or unknown to user 102 prior to receiving the gift entitlement. In certain embodiments, gift entitlement application 140 may establish a gift entitlement through a purchase of a gift entitlement with payment provider server 130. For example, payment provider server 130 may enable a user to purchase a monetary credit amount, credit for an item, or credit for a service as a gift entitlement. However, in other embodiments, a user may transmit a pre-purchased gift entitlement to payment provider server 130. In such embodiments, a user may purchase a gift entitlement with a merchant and utilize gift entitlement application 140 of payment provider server 130 to manage the gift entitlement.

Gift entitlement application 140 may include further features to establish gift entitlements for user 102 and/or other users. For example, user 102 may establish an account with payment provider server 130 and designate a gift entitlement user 102 may wish to receive (i.e. as a birthday or holiday present). Other users may then pay for the gift entitlement, potentially splitting the cost of the gift entitlement across several users. When the cost of the gift entitlement has been reached, it may be transmitted to user 102 when user 102 is determined to be in a gifting opportunity.

In other embodiments, gift entitlement application 140 may receive information corresponding to places user 102 visits and/or purchases items/services from, or may receive information corresponding to desired items/services of user 102. In various embodiments, gift entitlement application 140 may also track this information. Thus, when a grantor of a gift wishes to establish a gift entitlement for user 102, the user may see a list of preferred items, services, and/or merchants. This enables the grantor to make informed choices for a gift entitlement for user 102.

Gift entitlement application 140 may be further configured to receive notifications corresponding to user 102 in a gifting opportunity with a merchant, and determine if the gifting opportunity qualifies for a gift entitlement held by payment provider server 130. In this regard, gift entitlement application 140 may receive notifications from user device 110, merchant device 120, and/or other notification source corresponding to a gifting opportunity between user 102 and the merchant. Gift entitlement application 140 may receive a notification corresponding to a purchase request from wallet/payment application 112 in certain embodiments. In other embodiments, the purchase request notification may be transmitted from checkout/payment application 122 of merchant device 120 based on payment with a payment card and/or payment provider. Moreover, a gifting opportunity may correspond to user 102 being at a geographic location corresponding to a merchant. For example, user 102 may “check-in” using a mobile application, social networking provider, or other location determining entity, at a merchant location. In other embodiments, a GPS locator or mapping application may place user 102 at the merchant location.

Once a notification corresponding to a gifting opportunity is received by gift entitlement application 140, gift entitlement application 140 may check gift entitlements against the gifting opportunity and determine if a gifting opportunity qualifies for a gift entitlement. Gift entitlement application 140 may check the name and/or identifier associated with the gift entitlement to make the determination. Additionally, terms may be attached to the gift entitlement, which may be used to determine if the gifting opportunity qualifies for the gift entitlement. For example, the gift entitlement may be limited by terms governing a day, time, item, service, location, or other restriction on usage of the gift entitlement. User 102 may be limited to redeem the gift entitlement only on a birthday or holiday. User 102 may be limited to redeem the gift entitlement only in the morning, afternoon, or night. Additionally, user 102 may be limited to redeem the gift with another person, such as a significant other or the grantor of the gift entitlement. The gift entitlement may be limited to a specific item, service, of even merchant location (i.e. both merchant and a specific location of the merchant). The gift entitlement may ne unknown to user 102, such as a term to keep the gift entitlement a secret until it is transmitted for use by user 102. In other embodiments, a notification a gift entitlement is waiting for use by user 102 may be transmitted to user 102, such as “Alice bought you coffee at Merchant X, go to nearest Merchant X to redeem!” If the gifting opportunity qualifies for a gift entitlement, the gift entitlement may be transmitted for use by user 102. In various embodiments, the gift entitlement may be transmitted to user device 110, merchant device 120, or both user device 110 and merchant device 120.

Transaction processing application 132 may be configured to receive and/or transmit information from user device 110 and/or merchant device 120 for processing and completion of financial transactions. Transaction processing application 132 may include one or more applications to process financial transaction information from user 102 and/or merchant device 120. Transaction processing application 132 may further provide an interface for user 102 to enter and complete information corresponding to a financial transaction. Additionally, transaction processing application 132 may provide transaction histories, include receipts, for use by user device 110 and/or merchant device 120 to complete a financial transaction. Transaction processing application 132 may receive gifting opportunity information, such as a payment request between user device 110 and merchant device 120. Thus, gift entitlement application 140 may utilize transaction processing application to receive notifications of gifting opportunities between user 102 and a merchant.

In various embodiments, payment provider server 130 includes other applications 134 as may be desired in particular embodiments to provide features to payment provider server 130. For example, other applications 134 may include security applications for implementing server-side security features, programmatic server applications for interfacing with appropriate application programming interfaces (APIs) over network 150, or other types of applications. Other applications 134 may contain software programs, executable by a processor, including a graphical user interface (GUI), configured to provide an interface to a user.

Additionally, payment provider server 130 includes database 136. As previously discussed, user 102 may establish one or more user accounts with payment provider server 130. User accounts in database 136 may include user information, such as name, address, birthdate, payment/funding information, additional user financial information, and/or other desired user data. User 102 may link user accounts to user device 110 through a user device identifier. Thus, when a device identifier corresponding to user device 110 is transmitted to payment provider server 130, e.g. from user device 110 and/or merchant device 120, a user account belonging to user 102 may be found. In other embodiments, user 102 may not have previously established a user account.

In various embodiments, database 136 stores gift entitlements corresponding to user 102. Payment provider server 130 may store gift entitlement corresponding to user 102 prior to transmission to user 102, for example, after another user has purchased the gift entitlement with payment provider server 130 and/or transmitted the gift entitlement to payment provider server 130. Payment provider server 130 may store the gift entitlement with a user account corresponding to user 102 prior to transmission to user 102. However, in embodiments where user 102 does not have a user account with payment provider server 130, the gift entitlement may be stored with an identifier corresponding to user 102, such as a name, payment card number, email address, user device identifier, or other identification. After transmission of the gift entitlement to user 102, user 102 may choose to store the gift entitlement in database 136. Again, the gift entitlement may be stored with a user account or other identifier. If a gift entitlement is only partially used by user 102, user 102 may store the gift entitlement and the remaining balance in database 136. Thus, user 102 may utilize database 136 to review remaining gift entitlement balances. Additionally, a grantor of a gift entitlement may utilize database 136 to review a summary of all sent balances from the grantors user account.

In various embodiments, payment provider server 130 includes at least one network interface component (NIC) 138 adapted to communicate with network 150 including user device 110 and/or merchant device 120. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

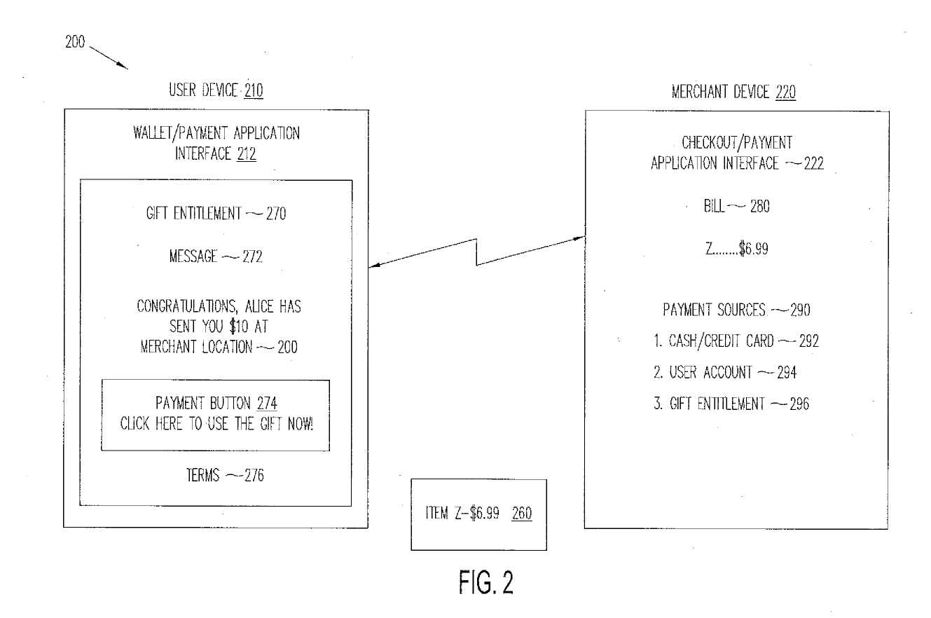

FIG. 2 is an exemplary gift entitlement delivery at a merchant location according to an embodiment. Merchant location 200 shows a user device displaying an application interface corresponding generally a software interface of a wallet/payment application, executable by one or more hardware processors. Additionally, merchant location 200 shows a merchant device displaying a checkout/payment application interface, executable by one or more hardware processors. User device 210 may display a gift entitlement corresponding to an item in merchant location 200. Thus, user device 210, wallet/payment application interface 212, merchant device 220, and checkout/payment application interface 222 of FIG. 2 may correspond generally to user device 110, wallet/payment application interface 120, merchant device 120, and checkout/payment application interface 122, respectively, of FIG. 1.

Merchant location 200 of FIG. 2 corresponds generally to a merchant location where a user may visit to purchase items and/or services. Thus, merchant location 200 includes user device 210 correspond to a user at a merchant location. Additionally, merchant location 200 includes item 260, which may correspond to an item purchasable from a user that either the user has selected for purchase, or may select for purchase. Item 260 may correspond to a specific gift entitlement, or the gift entitlement may correspond more generally to merchant location 200, for example, a general credit to the merchant. Merchant location 200 also includes merchant device 220 allowing the user to purchase item 260.

User device 210 of FIG. 2 displays wallet/payment application interface 212 including gift entitlement 270. As previously discussed, a gift entitlement may correspond to a credit for use by a user of user device 210 at merchant location 200. Gift entitlement 270 includes a message 272 having payment button 274 and terms 276. User device 210 may populate gift entitlement 270 after receiving gift entitlement 270 from a payment provider and/or merchant. Gift entitlement may be received when user device 210 is determined to be in a geographic area of merchant location 210 or when the user of user device 210 attempts to purchase item 260.

Gift entitlement 270 contains message 272. Message 272 may alert the user to the value of the gift entitlement and include other messages as determined when the gift entitlement is created and/or transmitted. For example, a user establishing the gift entitlement may wish to write a message to the recipient of the gift entitlement. In other embodiments, message 272 may include video, voice, or other message notifications. Thus, when user device 210 displays gift entitlement 270, a voice or video may playback in messages 272 for the recipient to view. As shown in FIG. 2, Alice has gifted $10 to a recipient at merchant location 200.

Message 272 includes a payment button 274. Payment button 274 may be configured to initiate a process to pay for a selected item/service using gift entitlement 270. By selecting payment button 274, gift entitlement 270 may be transmitted to merchant device 220 to process for payment of item 260. Payment button 274 may transmit information associated with gift entitlement 270, such as information enabling merchant device 220 to complete payment of item 260 (e.g. an account identifier, payment provider identifier, or other information necessary to receive funds for item 260).

Message 272 further includes terms 276. Terms 276 may or may not be displayed fully or partially to a recipient. Terms 276 may govern the use of the gift entitlement including the length of validity and locations where gift entitlement 270 is redeemable.

Merchant device 220 displays checkout/payment application interface 222. Checkout/payment application interface 222 may be configured to provide a convenient interface to enable a merchant to complete purchase of item 260. Thus, check/payment application interface 222 includes bill 280 showing item 260 for purchase, or “Z-$6.99.” Additionally, checkout/payment application interface 222 shows payment sources 290. Payment sources 290 may populate various entries based on interactions with a user of user device 210. For example, payment sources may only populate cash/credit card 292 if the user has not provided alternative payment methods, for example, using user device 210. If user device 210 is utilize to provide payment, user account 294 may populate, where user account 294 corresponds to payment using a user account with a payment provider. Additionally, if user device 210 transmits a gift entitlement to merchant device 220, gift entitlement 296 of payment sources 290 may populate. The user is then enabled to select a choice on payment of bill 280 for item 260.

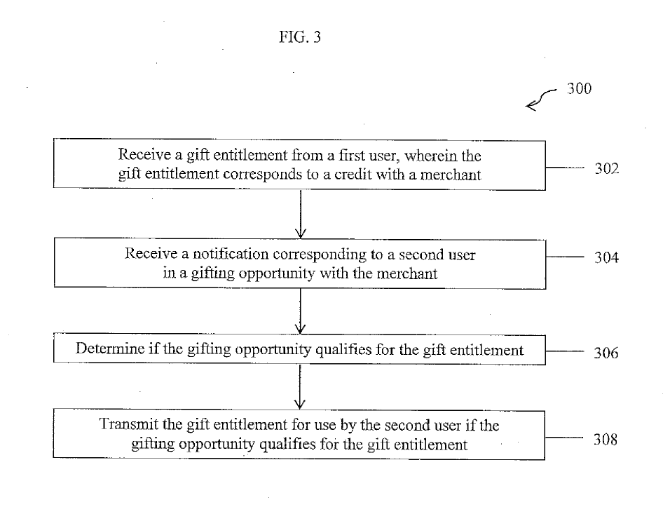

FIG. 3 is a flowchart of an exemplary process for gift entitlements to a user after determining a user is in a gifting opportunity at a merchant according to an embodiment. Note that one or more steps, processes, and methods described herein may be omitted, performed in a different sequence, or combined as desired or appropriate.

At step 302, a gift entitlement is received from a first user by a merchant server or a payment provider server, wherein the first entitlement corresponds to a credit a with a merchant. The credit may correspond to a monetary credit, a credit to purchase an item, a credit for services provided by the merchant, or other credit. The first user may set terms with the gift entitlement, such as terms corresponding to the redemption of the gift entitlement. In other embodiments, the terms may govern the transmission of the gift entitlement, such as a time, precondition, or location.

A notification corresponding to a second user in a gifting opportunity with the merchant may be received by the merchant server and/or payment provider server, at step 304. The gifting opportunity may correspond to an opportunity to provide a gift entitlement to the second user. Thus, the notification may correspond to a payment request at the merchant by the second user in certain embodiments. The payment request may be a request to pay using a payment provider or a request to pay using a payment card of the user. In other embodiments, the notification may be received by the merchant server and/or payment provider server because the second user is in a geographic area corresponding to the merchant. Thus, the gifting opportunity may correspond to an opportunity to surprise the second user with a merchant credit while the second user is at the merchant location.

At step 306, the merchant server and/or payment provider server may determine if the gifting opportunity qualifies for the gift entitlement. The gifting opportunity may qualify for the gift entitlement if the preconditions to redemption and/or transmission of the gift entitlement are met, such as a time, precondition, location, or other term.

The gift entitlement is transmitted for use by the second user if the gift opportunity qualifies for the gift entitlement at step 308. The gift entitlement may be transmitted to a user device of the second user or may be transmitted to a merchant device. For example, where the user is visiting a merchant location, the gift entitlement may be transmitted to a user device corresponding to the second user and notifying the second user of the gift entitlement. In another example, the gift entitlement may be transmitted to a merchant device corresponding to a merchant when the second user attempts to pay for an item/service. The gift entitlement may be unknown to the second user, so that the gift entitlement is a surprise to the second user. However, in other embodiments, the second user may receive a message that a gift entitlement is waiting redemption by the second user, as well as the terms to redemption of the gift entitlement.

The second user may then use the gift entitlement to complete a payment using the gift entitlement, for example a purchase of an item/service. In other embodiments, the second user may wish to store the gift entitlement for later use. The gift entitlement may be stored to a digital wallet of the second user on a user device, such as a smart phone, PDA, tablet computer, or other device. In other embodiments, the second user may transmit the gift entitlement to a merchant server and/or payment provider server for storage in a user account and future use.

In various embodiments, the grantor of a gift entitlement may access a payment provider and review a summary of all purchased and/or transmitted gift entitlements. The grantor may review gift entitlement wait redemption and gift entitlement used and/or partially used. Additionally, a recipient of a gift entitlement may utilize the payment provide to store fully and/or partially used gift entitlements, and access the payment provider to review a summary of all gift entitlement balances. The recipient may also utilize a digital wallet, such as a wallet/payment application, to keep a summary of all gift entitlement balances.

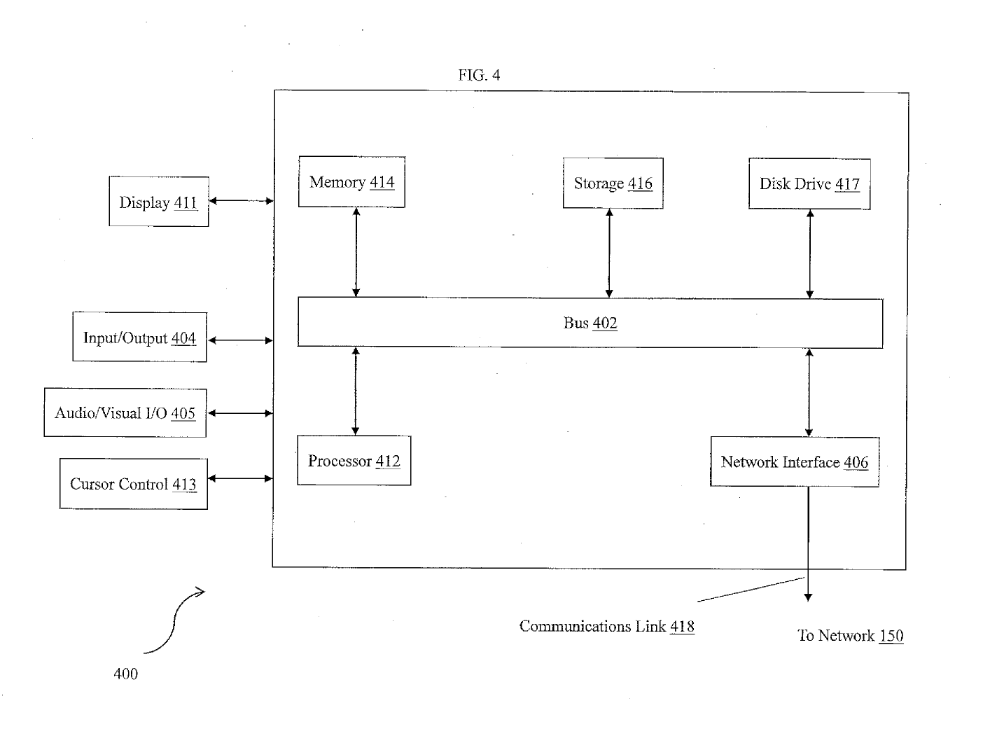

FIG. 4 is a block diagram of a computer system 400 suitable for implementing one or more embodiments of the present disclosure. In various embodiments, the user device may comprise a personal computing device (e.g., smart phone, a computing tablet, a personal computer, laptop, FDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons, image, or links, and/or moving one or more images, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a service provider server via network 150. In one embodiment, the transmission is wireless, although other transmission mediums and methods may also be suitable. One or more processors 412, which can be a micro-controller, digital signal processor (DSP), or other processing component, processes these various signals, such as for display on computer system 400 or transmission to other devices via a communication link 418. Processor(s) 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor(s) 412 and other components by executing one or more sequences of instructions contained in system memory component 414. Logic may be encoded in a computer readable medium, which may refer to any medium that participates in providing instructions to processor(s) 412 for execution. Such a medium may take many forms, including but not limited to, non-volatile media, volatile media, and transmission media. In various embodiments, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing user account information, wherein the user account information comprises user financial information; and
one or more hardware processors in communication with the non-transitory memory and configured to:
receive a gift entitlement from a first user, wherein the gift entitlement corresponds to a credit with a merchant;
receive a notification corresponding to a second user in a gifting opportunity with the merchant;
determine if the gifting opportunity qualifies for the gift entitlement;
transmit the gift entitlement for use by the second user if the gifting opportunity qualifies for the gift entitlement.

2. The system of claim 1, wherein the notification corresponds to a payment request.

3. The system of claim 2, wherein the payment request is a request to pay using a payment provider.

4. The system of claim 2, wherein the payment request is a request to pay using a payment card.

5. The system of claim 1, wherein the notification corresponds to a geographic location of the merchant and the second user.

6. The system of claim 1, wherein the one or more hardware processors are further configured to:
complete a payment using the gift entitlement.

7. The system of claim 1, wherein the gift entitlement further includes terms corresponding to redemption of the gift entitlement.

8. The system of claim 1, wherein the gift entitlement is transmitted to one of the second user and the merchant.

9. The system of claim 1, wherein the notification is received from one of the second user and the merchant.

10. The system of claim 1, wherein the first entitlement is unknown to the second user prior to notification.

11. A method comprising:
receiving a gift entitlement from a first user, wherein the gift entitlement corresponds to a credit with a merchant;
receiving a notification corresponding to a second user in a gifting opportunity with the merchant;
determining, by a hardware provider of a server, if the gifting opportunity qualifies for the gift entitlement;
transmitting the gift entitlement for use by the second user if the gifting opportunity qualifies for the gift entitlement.

12. The method of claim 11, wherein the notification corresponds to a payment request.

13. The method of claim 11, wherein the notification corresponds to a geographic location of the merchant and the second user.

14. The method of claim 11, wherein the gift entitlement is transmitted to one of the second user and the merchant.

15. The method of claim 11, wherein the first entitlement is unknown to the second user prior to notification.

16. A non-transitory computer readable medium comprising a plurality of machine-readable instructions which when executed by one or more processors of a server are adapted to cause the server to perform a method comprising:
receiving a gift entitlement from a first user, wherein the gift entitlement corresponds to a credit with a merchant;
receiving a notification corresponding to a second user in a gifting opportunity with the merchant;
determining if the gifting opportunity qualifies for the gift entitlement;
transmitting the gift entitlement for use by the second user if the gifting opportunity qualifies for the gift entitlement.

17. The non-transitory computer readable medium of claim 16, wherein the notification corresponds to a payment request.

18. The non-transitory computer readable medium of claim 16, wherein the notification corresponds to a geographic location of the merchant and the second user.

19. The non-transitory computer readable medium of claim 16, wherein the gift entitlement is transmitted to one of the second user and the merchant.

20. The non-transitory computer readable medium of claim 16, wherein the first entitlement is unknown to the second user prior to notification.
